(19) United States
(12) Patent Application Publication
(10) Pub. No.: US 2006/0186864 A1
(43) Pub. Date: Aug. 24, 2006

(54) High voltage switching apparatus

(75) Inventors: Robert Richardson, Essex (GB); Stephen Mark Iskander, Essex (GB)

Correspondence Address: VENABLE LLP, P.O. BOX 34385, WASHINGTON, DC, 20045-9998, US

(73) Assignee: E2V Technologies (UK) Limited, Essex (GB)

(21) Appl. No.: 11/357,422

(22) Filed: Feb. 21, 2006

(30) Foreign Application Priority Data
Feb. 18, 2005 (GB) 0503439.2

(51) Int. Cl. G05F 1/70; G05F 3/00

(52) U.S. Cl. 323/208

(57) ABSTRACT

A switching arrangement for a high voltage load provides high voltage pulses to the load. The switching arrangement includes N switching modules where N is typically 75. A load capacitance of Cd is required to avoid voltage overshoot at the load and is provided by a capacitance of nCd arranged in parallel with each switch. In addition, a graded capacitance is arranged across each switch. The graded capacitance compensates for unequal voltage sharing during high transience. The graded capacitance and the distributed load capacitance may be arranged as a single capacitance across each switch.

### CROSS-REFERENCE TO RELATED APPLICATION

This application claims the priority of British Patent Application No. 0503439.2 filed on Feb. 18, 2005, the subject matter of which is incorporated herein by reference.

### BACKGROUND OF THE INVENTION

This invention relates to high voltage switching apparatus, and in particular, but not exclusively, to a switching apparatus for providing pulses to a pulse switched load.

Our UK patent applications GB-A-9929074.5 and GB-A-9928049.7 describe a pulsed switching apparatus for an eht load such as a magnetron. A stack of FET switch modules are arranged in an oil-filled chamber surrounded by four capacitors which are mounted within a plastics housing. The switch stack receives an eht supply, typically at about −55 kV and delivers a series of eht pulses to the magnetron. The switch also includes the various control circuitry which operates at lt voltages. This circuitry controls functions such as triggering of the FET switches.

In these devices, when the load is switched, it is desirable for the voltage to rise smoothly to the operating voltage. In practice, however, there is a tendency to a voltage overshoot. This is because the load is not a purely resistive load but is of a non-linear nature and includes a small capacitive component. A known way of correcting for this voltage overshoot is to include a further capacitance in parallel with the load. The problem with this approach is that the added capacitance is large, typically in the order of 200 pF, expensive and physically large.

Our International patent application WO 02/103904 solves this problem by distributing the load capacitance evenly across the switching modules. In one embodiment disclosed, each switching module has an identical capacitance nCd in parallel with the switch module where Cd is the required additional capacitance and n is the number of switching modules. The distribution of the load capacitance across the switching stack helps to swamp the effects of stray capacitances in the stack. It also allows relatively inexpensive capacitances to be used instead of a single expense load capacitor.

Although this arrangement is advantageous it does not give ideal performance.

A paper by G. Bredenkamp et al. “Transient Sharing in Series Coupled High Voltage Switches” (1991 Pulse Power Symposium) identifies a problem with unequal voltage sharing during high speed transience. It was already known to reduce overvoltage ratios by coupling a capacitor across each switch, which is often done to protect against overly high voltage/time gradients. Such capacitances are typically much lower than the distributed load capacitances of WO 02/103904. The Bredenkamp et al paper proposes that much smaller capacitances are coupled across the switches but with graded values which exactly compensate for the additional current drawn by the parasitic capacitances in each of the switches.

Although the prior art discussed above teaches the use of graded much smaller capacitances, we have appreciated that these capacitances may be combined with the distributed load capacitance to control the rise time of the switches. This is of particular advantage where the switching the arrangement is used to drive a magnetron although it also has advantages in other applications.

### SUMMARY OF THE INVENTION

Accordingly, the present invention provides a high voltage switching arrangement for applying a pulse across a load, comprising a capacitor for providing electrical energy to the load, and a switch stack for connecting the capacitor to the load, the switch stack comprising a plurality of switches arranged in series, and a plurality of capacitances in parallel across the switches, wherein the parallel capacitances each comprise a distributed load component and a component to compensate for unequal voltage sharing during high transience, the compensation component being graded across the switches.

The load capacitance may be equal for each of the switches. This load capacitance may be equal to nCd, where Cd or the capacitance of the load, and n is the number of switches.

The load capacitance and graded capacitance components may comprise a single capacitor.

Groups of adjacent capacitors may have the same graded capacitance. These groups may comprise 3 or 5 capacitors.

### BRIEF DESCRIPTION OF THE DRAWINGS

An embodiment of the invention will now be described, by way of example and with reference to the accompanying drawings in which:

FIG. 1. is a schematic longitudinal view of a high voltage switching mechanism;

FIG. 2 is a schematic cross-section on the line V-V in FIG. 1; and

FIG. 3 shows how the load capacitance may be distributed and include a graded element in accordance with an embodiment of the invention.

### DETAILED DESCRIPTION OF THE INVENTION

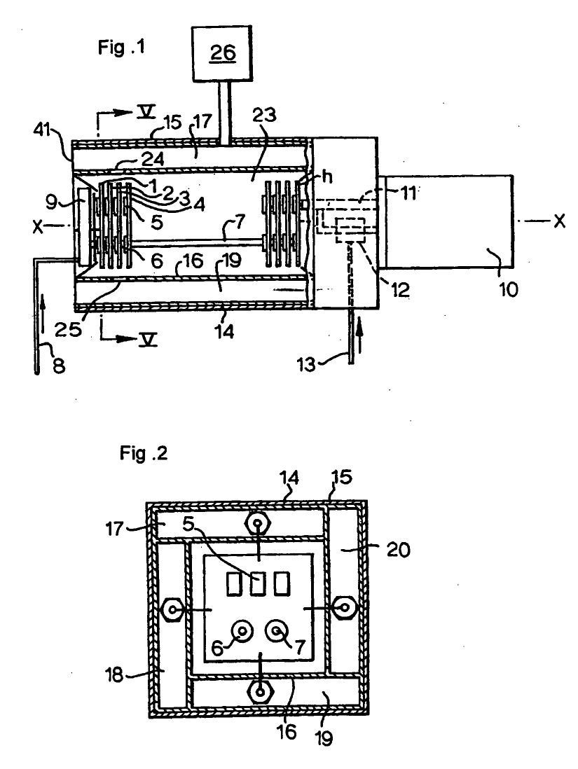

FIGS. 1 and 2 show the switching mechanism described in our earlier applications, GB 2298074.5 and GB 9928049.7. The mechanism provides high voltage pulses to a high voltage load, such as a magnetron, by switching a capacitance. The switching is triggered by trigger pulses derived from a high voltage supply and the capacitance is also charged by that supply.

The switching arrangement shown in FIGS. 1 and 2 comprises a switch stack arranged within a chamber surrounded by a plurality of capacitances. The switch stack comprises a number of FET modules 1, 2, 3, 4, . . . n, each of which includes one or more FET switches. There may be, for example, 75 FET modules in the stack and each module may include three FET switches. The modules are mounted in close proximity to one another and are stacked along the axis in FIG. 1. As well as the FET switch, each module includes a secondary transformer winding 6 with a common primary winding 7 extending along the length of the axis to act as the primary for each module. The primary is to provide power to the FET switches. Power to the switching arrangement is applied from a source 8 to a trigger driver 9 at the high voltage end of the stack which is maintained at −55 kV. The trigger driver is formed as a module of similar dimensions to the FET modules and forms the end module to the stack. The load 10, for example, a magnetron, is connected to an output 11 of the switching mechanism to receive pulses from the switching mechanism. The output 11 also provides an output 12 to a heater transformer for heating the magnetron cathodes. The power for the transformer is provided from a power source 13.

The switching mechanism is arranged within a housing 14. The housing is formed of a non-conductive material such as a plastics material and comprises outer and inner walls 15, 16 defining an annular chamber therebetween, and an interior chamber 23 bounded by the inner walls and in which the switching stack is arranged. The annular chamber and the interior chamber communicate via apertures 24, 25 in the inner wall 16.

As can be seen from FIG. 2, the housing and the annular and interior chambers are rectangular in cross-section. Four capacitors 17, 18, 19, 20 are arranged in the annular chamber, one on each side, and extend along the length of the chamber shielding the switching mechanism. The capacitors are connected at the high voltage end of the first switch module and to the load 10 at the low voltage end, which may be at ground. The capacitors each comprise a plurality of parallel plates forming capacitor elements which are interconnected so that a nominally linear voltage gradient appears from the power end to the zero volt end. The capacitors may each be 0.15 μF.

The unit is oil filled for heat dissipation and insulation. Oil can pass between the annular and inner chambers through passageways 24, 25. An expansion tank 26 is connected to the chambers which includes a diaphragm, and which moves with the changes in oil volume, for example due to temperature changes. The switching stack also comprises a control module 40 which is mounted on the stack between the trigger driver module and the first FET module 1 and which is of similar dimensions to the FET modules. The control module controls triggering of the FET switches and floats at the high voltage of −55 kV but has its own lt power supply to operate the control circuitry.

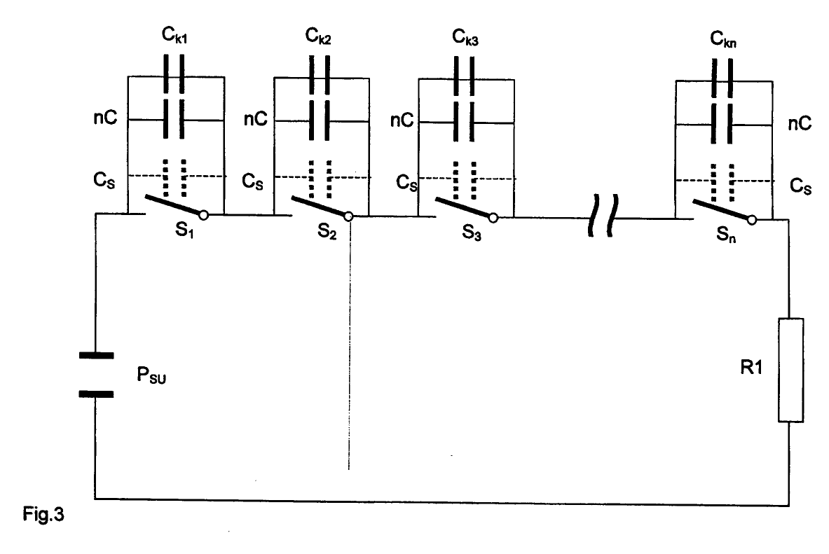

In the arrangement of FIG. 3, embodying the invention, there is shown a number of switches S1, S2, S3 . . . Sn. A typical switching apparatus contains a series of switch modules. In some cases about 75 switch modules. A capacitor is placed across each of the switch modules instead of a single capacitor across the load. In the prior art as shown in WO 02/103904 the value of each capacitor is nCd, where n is the number of switch modules or, effectively, the number of series connected capacitors. The value of nCd is such that the applied capacitance greatly exceeds and swamps any stray capacitances generated at the switch. The stray capacitance Cs is shown in phantom in FIG. 3 as the effect is minimal compared to the effect of nCd.

The embodiment of the present invention, as shown in FIG. 3, arranges a further capacitance Ck1-Ckn in parallel with the distributed load capacitances across each switching module. The value for Ck is different for each switching module and is determined by the formula:

$${C}_{k} = \frac{[ {K}^{2} + K ]}{2} \cdot {C}_{b}$$

Where K=N−1 where N is the module number; Cₖ is the capacitance required across the module to compensate for unequal voltage sharing during high transience; and Cₛ is the capacitance between the module and ground. For a switching module operating at 50 kV, and having 10 switching modules, assuming a constant value of 42 pF for C_{b}, the values of Cₖ will vary from 0 to about 2 nF across the stack.

Although shown as separate parallel capacitances in FIG. 3, the capacitance of Cₖ may be lumped together with the distributed load capacitances nCd so that there is a graded reduction in the load capacitances down the stack. This arrangement achieves near perfect sharing and retains the benefit of the distribution of the load capacitance.

In an application such as the 75 module example described above, it is not necessary that 75 difference capacitors are used. It is possible to grade using groups of capacitors of the same value, for example groups of 3 or 5.

Various modifications to the embodiments described are possible and will occur to those skilled in the art without departing from the scope of the invention which is defined solely by the following claims.

What is claimed is:

1. A high voltage switching arrangement for applying a pulse across a load, comprising a capacitor for providing electrical energy to the load, and a switch stack for connecting the capacitor to the load, the switch stack comprising a plurality of switches arranged in series, and a plurality of capacitances in parallel across the switches, wherein the parallel capacitances each comprise a distributed load component and a component to compensate for unequal voltage sharing during high transience, the compensation component being graded across the switches.

2. A switching arrangement according to claim 1, wherein the distributed load capacitance is equal for each of the switches.

3. A switching arrangement according to claim 2, wherein the load capacitance is equal to nCd where Cd is the capacitance of the load and n is the number of switches.

4. A switching arrangement according to claim 1, wherein the load capacitance component and the graded compensation component comprise a single capacitor.

5. A switching arrangement according to claim 1, wherein the value of the graded component is given by:
$${C}_{K} = \frac{[ {K}^{2} + K ]}{2} \cdot {C}_{b}$$

6. A switching arrangement according to claim 1, wherein the value of the graded component is different for each switch in the stack.

7. A switching arrangement according to claim 1, wherein the graded components are grouped together whereby groups of adjacent capacitors have the same graded component value.

8. A switching arrangement according to claim 7, wherein the groups of capacitors comprise 3 or 5 capacitors.
